(19) United States
(12) Patent Application Publication
(10) Pub. No.: US 2014/0245415 A1
(43) Pub. Date: Aug. 28, 2014

(54) Method and system for implementing directional publishing of information, and computer storage medium

(71) Applicant: TENCENT TECHNOLOGY (SHENZHEN) COMPANY LIMITED, (unknown)

(72) Inventor: Shaohua Luo, Shenzhen (CN)

(21) Appl. No.: 14/260,502

(22) Filed: Apr. 24, 2014

Related U.S. Application Data
(63) Continuation of application No. PCT/CN2013/073021, filed on Mar. 21, 2013.

(30) Foreign Application Priority Data
Mar. 26, 2012 (CN) 2012100823226

(51) Int. Cl. H04L 29/06; G06F 3/0484

(52) U.S. Cl. CPC H04L 63/12; G06F 3/0484
USPC 726/7

(57) ABSTRACT

It is described a method for implementing directional publishing of information, which includes: it is selected, for a client device or a browser which supports display of dynamic pictures, release information to be published based on a location of a current verification picture and a page topic associated with the location, current verification information being supposed to be input from the client device or the browser; and it is selected a picture corresponding to the selected release information, the selected picture and the verification picture are processed to obtain a dynamic picture, and the obtained dynamic picture is displayed in an area for verification. Also it is provided a system for implementing directional publishing of information and a computer storage medium. With the described method and system, a verification code can be used to implement directional publishing of information, thereby increasing the utilization rate of the validate code.

### CROSS REFERENCE TO RELATED APPLICATIONS

This is a continuation application of International Patent Application No. PCT/CN2013/073021, filed on Mar. 21, 2013, which claims priority to Chinese Patent Application No. 201210082322.6 filed on Mar. 26, 2012, the disclosure of which is incorporated by reference herein in its entirety.

### TECHNICAL FIELD

The present disclosure relates to information processing on the Internet, and particularly to a method and system for implementing directional publishing of information, and a computer storage medium.

### BACKGROUND

In order to prevent aggressors from using robots to automatically register, log in, spam an internet forum or test weak passwords of an account, verification code (CAPTCHA, Completely Automated Public Turing test to tell Computers and Humans Apart)) technology is employed by a lot of websites. There has already been relatively mature verification code technology, which has been applied in most websites. For example, the verification codes can be seen on many client devices or on each page of many internet operators. However, there has not been discussed how to make a profit by using the verification code. When there is a need for a user to input a verification code on a web page, the verification code earns the greatest focus of the user within the web page, and thus is superexcellent for publishing of release information, which will be undoubtedly seen by the user. If release information is selected based on a verification code and its various attributes, the value brought by the release information would be significant.

In a relevant art, since the verification code is of single frame, it is relatively easy to perform an image analysis through verification code recognition technology and thus complete the recognition of the verification code. It is known that a server which provide verification code services is a kind of thing that usually needs a lot of fund and is unlikely make a quick profit. In addition, position resources of a website for release information is very limited currently, it is hence difficult to expand the function of a verification code.

### SUMMARY

The embodiments of the disclosure is to provide a method and system for implementing directional publishing of information, and a computer storage medium.

The embodiments of the disclosure provide a method for implementing directional publishing of information, which includes:

It is selected, for a client device or a browser which supports display of dynamic pictures, release information to be published based on a location of a current verification picture and a page topic associated with the location, current verification information being supposed to be input from the client device or the browser; and

it is selected a picture corresponding to the selected release information, the selected picture and the verification picture are processed to obtain a dynamic picture, and the obtained dynamic picture is displayed in an area for verification.

The embodiments of the disclosure provide a system for implementing directional publishing of information, which includes:

a selection portion configured to, select for a client device or a browser which supports display of dynamic pictures, release information to be published based on a location of a current verification picture and a page topic associated with the location, current verification information being supposed to be input from the client device or the browser; and

a processing portion configured to select a picture corresponding to the selected release information, process the selected picture and the verification picture to obtain a dynamic picture, and display the obtained dynamic picture in an area for verification.

The embodiments of the disclosure provides a computer storage medium storing a computer program thereon for executing said method for implementing directional publishing of information.

According to the method and system for implementing directional publishing of information, and the computer storage medium provided by embodiments of the disclosure, when a client device or a browser (current verification information is supposed to be input from the client device or the browser) supports display of dynamic pictures, it is selected, for the client device or the browser, release information to be published based on a location of a current verification picture and a page topic associated with the location, and then it is selected a picture corresponding to the selected release information, the selected picture and the verification picture are processed to obtain a dynamic picture, and the obtained dynamic picture is displayed in an area for verification. Therefore, the release information can be published together with the verification code, thereby the utilization rate of the verification code is improved.

It is known that the verification code is widely used, we can therefore select different release information corresponding contents of different web pages which contain verification codes. As such, it is brought a significant information advertising effectiveness, and directional area for release information is increased, thus yielding notable economic benefit.

### BRIEF DESCRIPTION OF THE DRAWINGS

FIG. 1 is a flowchart illustrating a method for implementing directional publishing of information according to an embodiment of the disclosure;

FIG. 2 is a schematic diagram illustrating a structural of a system for implementing directional publishing of information according to an embodiment of the disclosure.

### DETAILED DESCRIPTION

In an embodiment of the disclosure, when a client device or a browser (current verification information is supposed to be input from the client device or the browser) supports display of dynamic pictures, it is selected, for the client device or the browser, release information to be published based on a location of a current verification picture and a page topic associated with the location, and then it is selected a picture corresponding to the selected release information, the selected picture and the verification picture are processed to obtain a dynamic picture, and the obtained dynamic picture is displayed in an area for verification.

The disclosure hereinafter will be described in more details with reference to embodiments in combination with appended drawings.

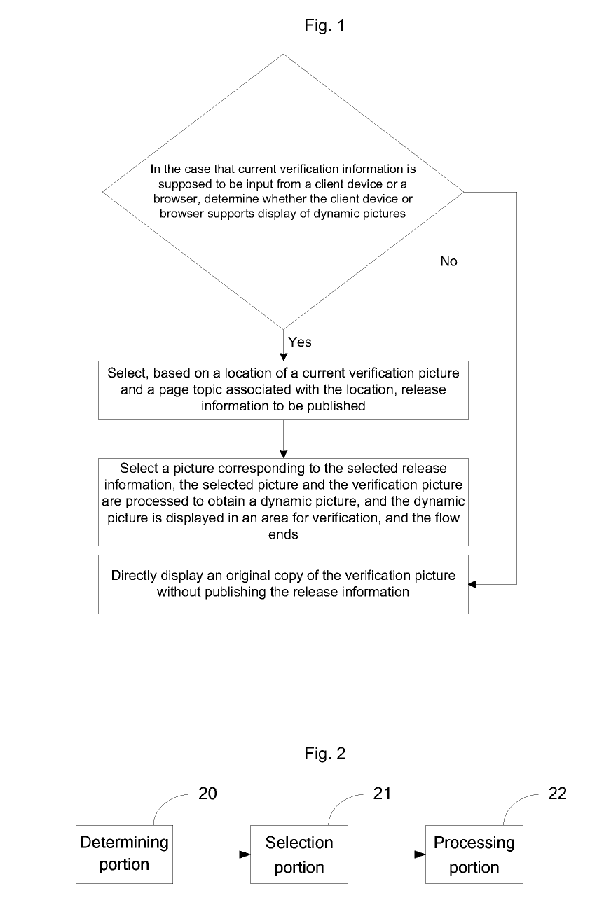

The embodiments of the disclosure provide a method for implementing directional publishing of information. FIG. 1 is a flowchart illustrating a method for implementing directional publishing of information according to an embodiment of the disclosure. As shown in FIG. 1, the method includes the following steps.

In Step 101, in the case that current verification information is supposed to be input from a client device or a browser, it is determined whether the client device or browser supports display of dynamic pictures, if yes, proceed to Step 102; otherwise, proceed to Step 104.

Since release information is a dynamic picture, for example a GIF dynamic picture, it is firstly necessary to determine whether the client device or the browser supports the display of dynamic pictures. If the client device or the browser supports the display of dynamic pictures, turn to Step 102. If the client device or the browser does not support the display of dynamic pictures, turn to Step 104.

Here, it may be determined whether the client device or the browser supports the display of dynamic pictures based on User Agent header information of the client device or the browser.

The verification information may be a verification code or a verification image.

The verification picture may be a picture including verification information.

In Step 102, it is selected, based on a location of a current verification picture and a page topic associated with the location, release information to be published.

At first, it may be determined a location of a current verification picture based on its aid (area id) parameter, and it may be determining a type of release information to be published based on the location of the current verification picture. The aid parameter may be the id of the channel where the verification code is located, or an area id of a sub-website. The location of the current verification picture may be a microblog, a home page of an official website, a homepage of a search engine. Then, it may be determined a page topic of the current verification picture based on its tag parameter and its location. It may be selected release information having the determined type and the determined page topic as those to be published before the verification picture, so as to implement directional publishing of information. The tag parameter may be preconfigured based on a page topic, or may be obtained from keywords contained in meta information of a page.

In some examples, if the location of the current verification picture is a web page designed for women on website A, then the release information may be information relative to women, such as beauty salon, slimming, fashion trends. Then it may be known based on the tag parameter that the page topic of the current verification picture is beauty salon, and accordingly the release information may be content related with cosmetics or hair styling products.

In Step 103, it is selected a picture corresponding to the selected release information, the selected picture and the verification picture are processed to obtain a dynamic picture, and the dynamic picture is displayed in an area for verification. The flow ends.

It may be searched, in a backend database of a network server, for a picture corresponding to the selected release information. A searched-out picture may be preprocessed by means of Imagick extension function, in particular, a time interval is set between a plurality of pictures. It may be combined a plurality of single-frame pictures into continuous dynamic pictures which are taken as the release information to be published before the verification picture. The dynamic pictures may be compressed together with the verification picture to obtain a new dynamic picture and the obtained new dynamic picture is displayed in the area for verification, so that information can be published in the area for verification.

According to embodiments of the disclosure, a dynamic picture of 1-3 frames may be inserted as the release information prior to the verification picture, and the length of time for the release information may be controlled within 2s. Here, default release information may be displayed, if no corresponding picture can be found in the back-end database of the network server, for example, the relevant pictures or part of the pictures have already exceeded the daily quota and thus are inactive.

After release information is placed before the verification picture, a release effectiveness of the release information may be measured through a release system and a statistical system in a platform for release information. In one embodiment, the platform may be for example, software stored in a server for implementing publishing of information. In some examples, the platform may be an advertisement Exchange platform.

In Step 104, it is directly displayed an original copy of the verification picture without publishing the release information.

In embodiments of the disclosure, a charging scheme for the release information may include CPM, CPD or CPC.

Accordingly, the embodiments of the disclosure further provide a system for implementing directional publishing of information. Referring to FIG. 2, which is a schematic diagram illustrating a structural of a system for implementing directional publishing of information according to an embodiment of the disclosure, the system includes:

a selection portion 21 configured to, select for a client device or a browser which supports display of dynamic pictures, release information to be published based on a location of a current verification picture and a page topic associated with the location, current verification information being supposed to be input from the client device or the browser; and

a processing portion 22 configured to select a picture corresponding to the selected release information, process the selected picture and the verification picture to obtain a dynamic picture, and display the obtained dynamic picture in an area for verification.

The system may further include: a determining portion 20 configured to determine whether the client device or the browser supports display of dynamic pictures.

The processing portion 22 may be further configured to, directly display an original copy of the current verification picture without publishing the release information, in the case it is determined that the client device or the browser does not support display of dynamic pictures.

The determining portion 20 may be configured to: determine whether the client device or the browser supports display of dynamic pictures based on User Agent header information of the client device or the browser.

The selection portion 21 may be configured to:

determine a location of a current verification picture based on its aid parameter, and determine a type of release information to be published based on the location of the current verification picture; and determine a page topic of the current verification picture based on its tag parameter, select release information having the determined type and page topic as those to be published before the verification picture so as to implement directional publishing of information.

The selection portion 21 may be configured to:

search, in a backend database of a network server, for a picture corresponding to the selected release information, preprocess a searched-out picture by means of Imagick extension, combine a plurality of single-frame pictures into continuous dynamic pictures; and

compress the dynamic pictures together with the verification picture to obtain a new dynamic picture and display the obtained new dynamic picture in the area for verification so that information can be published in the area for verification.

When implemented in form of a software functional module and sold or used as an independent product, the system for implementing directional publishing of information in an embodiment of the present disclosure may be stored in a computer-readable storage medium. Based on such an understanding, the essential part (or a part of the technical solution of an embodiment of the present disclosure contributing to prior art) may appear in form of a software product, which software product is stored in a storage medium, and includes a number of instructions for allowing a computing equipment (such as a personal computer, a server, a network equipment, or the like) to execute all or part of the methods in various embodiments of the present disclosure. The storage media include various media that can store program codes, such as a U disk, a mobile hard disk, a Read-Only Memory (ROM), a Random Access Memory (RAM), a magnetic disk, a CD, and the like. Thus, an embodiment of the present disclosure is not limited to any specific combination of hardware and software.

Accordingly, an embodiment of the disclosure further provides a computer storage medium storing a computer program thereon for executing a method for implementing directional publishing of information described in an embodiment of the disclosure.

What described are merely preferred embodiments of the disclosure, and are not intended to limit the scope of the present disclosure. Any modification, equivalent replacement, improvement, and the like made within the principle of the present disclosure should be included in the scope of the present disclosure.

1. A method for implementing directional publishing of information, comprising:
selecting, for a client device or a browser which supports display of dynamic pictures, release information to be published based on a location of a current verification picture and a page topic associated with the location, current verification information being supposed to be input from the client device or the browser; and
selecting a picture corresponding to the selected release information, processing the selected picture and the verification picture to obtain a dynamic picture, and displaying the obtained dynamic picture in an area for verification.

2. The method according to claim 1, further comprising: prior to the selecting release information to be published based on a location of a current verification picture and a page topic associated with the location,
determining whether the client device or the browser supports display of dynamic pictures and if no, directly displaying an original copy of the current verification picture without publishing the release information.

3. The method according to claim 2, wherein the determining whether the client device or the browser supports display of dynamic pictures comprises:
determining whether the client device or the browser supports display of dynamic pictures based on User Agent header information of the client device or the browser.

4. The method according to claim 1, wherein the selecting release information to be published based on a location of a current verification picture and a page topic associated with the location comprises:
determining a location of a current verification picture based on its aid parameter, determining a type of release information to be published based on the location of the current verification picture; and
determining a page topic of the current verification picture based on its tag parameter, selecting release information having the determined type and page topic as those to be published before the verification picture so as to implement directional publishing of information.

5. The method according to claim 1, wherein the selecting a picture corresponding to the selected release information, processing the selected picture and the verification picture to obtain a dynamic picture, and displaying the obtained dynamic picture in an area for verification comprises:
searching, in a backend database of a network server, for a picture corresponding to the selected release information, preprocessing a searched-out picture by means of Imagick extension, combining a plurality of single-frame pictures into continuous dynamic pictures; and
compressing the dynamic pictures together with the verification picture to obtain a new dynamic picture and displaying the obtained new dynamic picture in the area for verification so that information can be published in the area for verification.

6. The method according to claim 5, further comprising: displaying default release information in the case that there is no corresponding pictures found in the backend database of the network server.

7. A system for implementing directional publishing of information, comprising:
a selection portion configured to, select for a client device or a browser which supports display of dynamic pictures, release information to be published based on a location of a current verification picture and a page topic associated with the location, current verification information being supposed to be input from the client device or the browser; and
a processing portion configured to select a picture corresponding to the selected release information, process the selected picture and the verification picture to obtain a dynamic picture, and display the obtained dynamic picture in an area for verification.

8. The system according to claim 7, further comprising a determining portion configured to determine whether the client device or the browser supports display of dynamic pictures,
wherein the processing portion is further configured to, directly display an original copy of the current verification picture without publishing the release information, in the case it is determined that the client device or the browser does not support display of dynamic pictures.

9. The system according to claim 8, wherein the determining portion is configured to: determine whether the client device or the browser supports display of dynamic pictures based on User Agent header information of the client device or the browser.

10. The system according to claim 7, wherein the selection portion is configured to:
determine a location of a current verification picture based on its aid parameter, and determine a type of release information to be published based on the location of the current verification picture; and
determine a page topic of the current verification picture based on its tag parameter, select release information having the determined type and page topic as those to be published before the verification picture so as to implement directional publishing of information.

11. The system according to claim 7, wherein the selection portion is configured to:
search, in a backend database of a network server, for a picture corresponding to the selected release information, preprocess a searched-out picture by means of Imagick extension, combine a plurality of single-frame pictures into continuous dynamic pictures; and
compress the dynamic pictures together with the verification picture to obtain a new dynamic picture and display the obtained new dynamic picture in the area for verification so that information can be published in the area for verification.

12. A non-transitory computer-readable storage medium storing instructions thereon for execution by at least one processing circuit, the instructions comprising:
selecting, for a client device or a browser which supports display of dynamic pictures, release information to be published based on a location of a current verification picture and a cage tonic associated with the location, current verification information being supposed to be input from the client device or the browser; and
selecting a picture corresponding to the selected release information, processing the selected picture and the verification picture to obtain a dynamic picture, and displaying the obtained dynamic picture in an area for verification.

13. The non-transitory computer-readable storage medium according to claim 12, wherein the instructions further comprises: prior to the selecting release information to be published based on a location of a current verification picture and a page topic associated with the location,
determining whether the client device or the browser supports display of dynamic pictures and if no, directly displaying an original copy of the current verification picture without publishing the release information.

14. The non-transitory computer-readable storage medium according to claim 13, wherein the determining whether the client device or the browser supports display of dynamic pictures comprises:
determining whether the client device or the browser supports display of dynamic pictures based on User Agent header information of the client device or the browser.

15. The non-transitory computer-readable storage medium according to claim 12, wherein the selecting release information to be published based on a location of a current verification picture and a page topic associated with the location comprises:
determining a location of a current verification picture based on its aid parameter, determining a type of release information to be published based on the location of the current verification picture; and
determining a page topic of the current verification picture based on its tag parameter, selecting release information having the determined type and page topic as those to be published before the verification picture so as to implement directional publishing of information.

16. The non-transitory computer-readable storage medium according to claim 12, wherein the selecting a picture corresponding to the selected release information, processing the selected picture and the verification picture to obtain a dynamic picture, and displaying the obtained dynamic picture in an area for verification comprises:
searching, in a backend database of a network server, for a picture corresponding to the selected release information, preprocessing a searched-out picture by means of Imagick extension, combining a plurality of single-frame pictures into continuous dynamic pictures; and
compressing the dynamic pictures together with the verification picture to obtain a new dynamic picture and displaying the obtained new dynamic picture in the area for verification so that information can be published in the area for verification.

17. The non-transitory computer-readable storage medium according to claim 16, wherein the instructions further comprises: displaying default release information in the case that there is no corresponding pictures found in the backend database of the network server.
